(19) United States
(12) Patent Application Publication
(10) Pub. No.: US 2026/0131909 A1
(43) Pub. Date: May 14, 2026

(54) SYSTEM AND METHOD FOR AUTOMATED PRE-LAUNCH AND POST-LAUNCH INSPECTION OF SPACE LAUNCH VEHICLES AND INFRASTRUCTURE USING COORDINATED DRONE SWARMS

(71) Applicant: Daniel Ryan Singleton, Huntsville, AL (US)

(72) Inventor: Daniel Ryan Singleton, Huntsville, AL (US)

(21) Appl. No.: 19/439,347

(22) Filed: Jan. 3, 2026

Related U.S. Application Data
(60) Provisional application No. 63/717,781, filed on Nov. 7, 2024.

(51) Int. Cl. B64G 5/00; B64U 20/30; B64U 20/60; B64U 20/80; B64U 50/10; B64U 50/38; B64U 101/30

(52) U.S. Cl. CPC B64G 5/00; B64U 20/30; B64U 20/60; B64U 20/80; B64U 50/10; B64U 50/38; B64U 2101/30; B64U 2201/102

(57) ABSTRACT

A system and method are provided for automated pre-launch and post-launch inspection of space launch vehicles and associated launch infrastructure using coordinated swarms of unmanned aerial vehicles (UAVs). In one implementation, multiple autonomous UAVs equipped with multi-modal sensors and protective design features execute coordinated inspection patterns under control of a mission management system that adapts to environmental conditions and enforces safety constraints. Sensor data are processed to detect and classify anomalies, generate inspection reports, and store results for trending analysis and predictive maintenance.

### CROSS-REFERENCE TO RELATED APPLICATIONS

This application claims the benefit of U.S. Provisional Patent Application No. 63/717,781, filed Nov. 7, 2024, titled “System and Method for Automated Pre-Launch and Post-Launch Inspection of Space Launch Vehicles and Infrastructure Using Coordinated Drone Swarms,” pursuant to 35 U.S.C. § 119 (e). The entire disclosure of the provisional application is incorporated by reference herein.

### STATEMENT REGARDING FEDERALLY SPONSORED RESEARCH OR DEVELOPMENT

Not applicable.

### FIELD OF THE INVENTION

This invention relates to aerospace ground operations and safety inspections and, more particularly, to automated systems and methods for conducting comprehensive pre-launch and post-launch inspections of space launch vehicles, launch pads, and associated ground support equipment using coordinated swarms of unmanned aerial vehicles (UAVs).

### BACKGROUND OF THE INVENTION

Space launch operations require extensive pre-launch and post-launch inspection activities to confirm vehicle integrity, verify pad readiness, detect hazardous conditions (e.g., propellant leaks), and document post-launch damage or anomalies. Traditional manual inspection procedures can be time-consuming, require close human proximity to hazardous environments, and may be limited by access constraints, weather, or time-critical launch operations.

Existing inspection methods often rely on fixed cameras, manned walkdowns, or single-drone flights. These approaches may be insufficient for rapid, high-resolution coverage of complex vehicle geometries and ground infrastructure, and may not provide the redundancy and coordination required to sustain safe operations in dynamic launch environments.

Accordingly, there is a need for an automated inspection capability that can (i) rapidly generate comprehensive inspection coverage, (ii) adapt to environmental and operational constraints, (iii) provide robust safety and redundancy, and (iv) deliver actionable anomaly detection and reporting in near real time.

### SUMMARY OF THE INVENTION

The present invention provides systems and methods for automated pre-launch and post-launch inspection of space launch vehicles and associated infrastructure using coordinated drone swarms. Multiple autonomous UAVs, equipped with multi-modal sensors and protective design features, cooperate as a coordinated swarm to perform synchronized multi-point inspections.

In some embodiments, the system includes: (i) a plurality of autonomous UAVs with heat-resistant outer structures, electromagnetic interference (EMI) shielding, redundant propulsion, modular sensor mounts, and secure communications; (ii) a control system configured to coordinate drone motion, allocate inspection tasks, and enforce safety protocols; (iii) launch-pad infrastructure including charging stations and secure communication nodes; and (iv) a data processing system configured to fuse sensor data, detect anomalies using machine learning, and generate automated inspection reports.

The invention can improve inspection efficiency, reduce human exposure to hazardous environments, and increase inspection coverage and reliability as compared to manual procedures. The described embodiments are illustrative and not limiting; additional configurations and variations may be implemented consistent with the principles described herein.

### BRIEF DESCRIPTION OF THE DRAWINGS

The present invention will be better understood from the following detailed description, in conjunction with the accompanying drawings, in which:

FIG. 1 is a system overview diagram illustrating an inspection-zone configuration for a coordinated drone swarm inspection system, showing the spatial relationship between multiple inspection drones (D1-D6), a launch vehicle (310), launch infrastructure (320), inspection zones (331-333), sensor coverage patterns (340), a charging station (350), an emergency landing zone (360), communication links (370), and a keep-out zone (380).

FIG. 2 is a schematic diagram illustrating an example drone platform architecture, including an EMI shielding layer (210), a heat-resistant shell (220), a redundant propulsion system (230) including primary motors (231) and backup motors (232), a modular sensor mount (240), a sensor suite (250) including a high-definition camera (251), an infrared sensor (252), a gas detection sensor (253), and a proximity sensor (254), an onboard processing unit (260), a secure communications module (270), and an inductive charging interface (280).

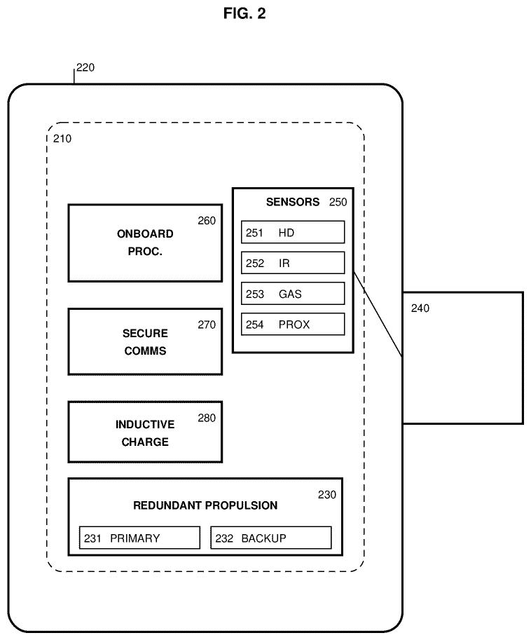

FIG. 3 is a functional block diagram illustrating an adaptive inspection control architecture, including an environmental monitoring system (410), an adaptive mission control system (420), a real-time analysis system (430), a safety management system (440), an inspection execution system (450), and a reporting and data management system (460).

While the invention is susceptible to various modifications and alternative forms, specific embodiments are shown by way of example in the drawings and described in detail. The intention is to cover all modifications, equivalents, and alternatives falling within the spirit and scope of the invention as defined by the appended claims.

### DETAILED DESCRIPTION OF THE INVENTION

The following description presents example embodiments for implementing coordinated UAV swarms to conduct automated inspection of launch vehicles and associated infrastructure. The terms “drone,” “UAV,” and “unmanned aerial vehicle” may be used interchangeably. The term “launch vehicle” includes orbital and suborbital rockets and associated stages, as well as integrated payload fairings or payload adapters, as applicable.

Base Platform Specifications (example embodiments). Each UAV may include one or more of the following features:
(a) multi-modal sensor packages including high-definition (HD) cameras, infrared (IR) sensors, gas detection sensors, and proximity sensors;
(b) heat-resistant outer structures and thermal protection materials configured to tolerate post-launch environments;
(c) EMI shielding and interference-resistant electronics configured for operation in high-EMI launch environments;
(d) redundant propulsion systems, including primary motors and backup motors with independent power distribution and automated switchover;
(e) modular sensor mounts and payload interfaces configured for rapid sensor replacement and reconfiguration;
(f) secure communications modules configured for encrypted transmission and authentication; and
(g) onboard processing units configured for edge computing, local anomaly screening, and bandwidth-efficient data products.

Pre-Launch Configuration (example embodiments). The system may be configured for pre-launch operations including one or more of the following:
(a) launch-pad and vehicle approach constraints implemented via geo-fencing and keep-out zones;
(b) mission planning to define inspection zones and coverage paths around the vehicle and ground support equipment;
(c) coordination with countdown procedures, including hold points, integrated checks, and range safety constraints; and
(d) safe operation during propellant loading, including vapor detection, leak localization, and emergency notification triggers.

Post-Launch Configuration (example embodiments). The system may be configured for post-launch rapid assessment including one or more of the following:
(a) thermal standoff constraints based on measured heat flux and IR observations;
(b) debris and foreign object debris (FOD) assessment using visual and mapping sensors;
(c) rapid launch pad damage inspection and flame deflector inspection;
(d) identification of residual propellant or hazardous vapors in the vicinity of the pad; and
(e) assessment of ground support equipment status and structural integrity.

Pre-Launch Inspection Capabilities (example embodiments). The coordinated swarm may perform one or more of the following:
(a) visual inspection of vehicle surfaces for cracks, dents, missing fasteners, ice formation, or foreign objects;
(b) thermal mapping to identify abnormal cold/heat spots, insulation issues, or unexpected thermal gradients;
(c) gas detection to identify and localize potential propellant leaks (e.g., hydrogen, oxygen, methane, kerosene vapors);
(d) verification of umbilical connections and ground support interface regions using close-range optical inspection;
(e) inspection of confined or occluded regions using small UAV trajectories and multi-angle viewing;
(f) verification of lightning protection systems and range instrumentation readiness, where applicable;
(g) monitoring of propellant loading operations through continuous sensing and alert thresholds;
(h) verification of safety perimeter compliance through geofencing and detection of unauthorized intrusions; and
(i) generation of pre-launch inspection reports including annotated imagery and identified anomalies.

Post-Launch Inspection Capabilities (example embodiments). After launch, the coordinated swarm may perform one or more of the following:
(a) rapid heat damage assessment via IR sensing, including identification of hotspots on pad structures;
(b) mapping and documentation of debris fields and scorched regions using imaging and/or lidar-based mapping;
(c) inspection of flame deflectors, deluge systems, and pad cooling systems for damage or blockage;
(d) inspection of tower structures, access arms, and support equipment for deformation or damage;
(e) environmental assessment of potential chemical releases and residual vapors;
(f) automated generation of a post-launch anomaly report including prioritized findings and evidence references;
(g) trending analysis by comparing post-launch results to historical data for the same pad and vehicle configuration.

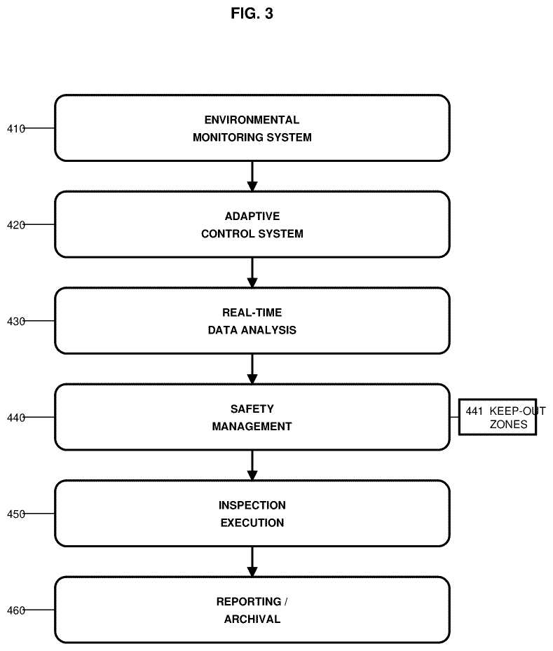

Swarm Coordination System (example embodiments). The control system (e.g., FIG. 3) may coordinate swarm operations including:
(a) distributed task allocation (e.g., zone coverage assignments) based on drone capability, sensor payload, and battery state;
(b) collective motion planning with collision avoidance, separation constraints, and dynamic replanning;
(c) synchronized sensor coverage patterns to reduce occlusions and ensure multi-angle observation;
(d) dynamic reallocation of tasks in response to faults, battery depletion, weather conditions, or mission updates; and
(e) formation optimization to balance coverage efficiency, safety margins, and communications quality.

Data Processing and Analysis (example embodiments). The data processing system may implement:
(a) edge processing on each UAV to pre-screen data and reduce uplink bandwidth requirements;
(b) sensor fusion, including temporal alignment of sensor streams and spatial alignment across multiple UAV viewpoints;
(c) machine learning-based anomaly detection, including classification of detected anomalies and confidence scoring;
(d) automated report generation with geotagged or pose-tagged evidence, prioritized findings, and recommended follow-up actions; and
(e) maintenance of a searchable database of historical inspection results for trend analysis and predictive maintenance.

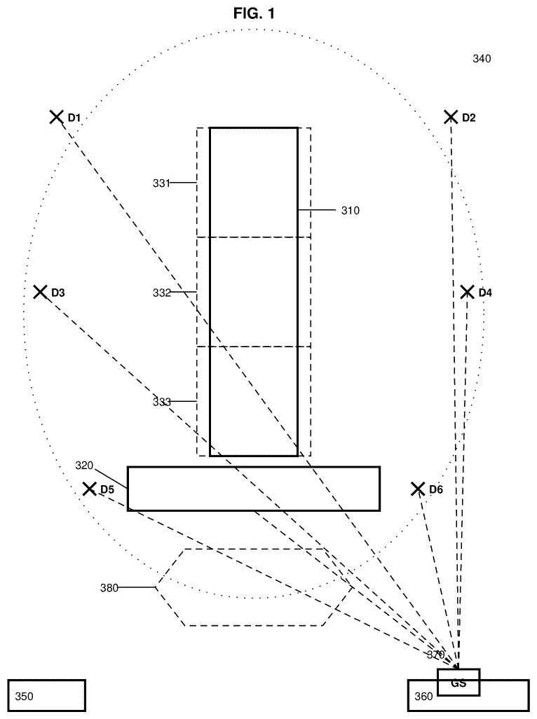

Safety Features and Operational Compliance (example embodiments). The system may include:
(a) multi-layer collision avoidance including proximity sensing, cooperative deconfliction, and emergency braking/hover logic;
(b) automated keep-out zone enforcement (e.g., FIG. 1 element 380 and FIG. 3 element 441) based on pad rules, hazard mapping, and real-time sensor triggers;
(c) redundant emergency landing and recovery procedures including designated landing zones (e.g., FIG. 1 element 360), return-to-home, and controlled descent;
(d) real-time monitoring of wind, precipitation, lightning, and other environmental parameters, with mission abort criteria and safe-state transitions;
(e) secure communications including encryption, authentication, and interference-resilient protocols suitable for high-EMI environments; and
(f) integration interfaces to coordinate with launch control procedures, range safety constraints, and facility safety rules.

System Integration Architecture and Methods (example embodiments). The system may integrate with one or more of the following:
(a) launch control systems for real-time status synchronization, countdown coordination, and inspection hold-point verification;
(b) range safety systems for geo-fencing, clearance verification, and position reporting;
(c) weather monitoring systems for lightning, wind, precipitation, and threshold management; and
(d) existing inspection systems (e.g., fixed cameras, ground radar, acoustic monitoring) to fuse heterogeneous data sources.

Communication and Data Management Architecture (example embodiments). The swarm may employ:
(a) mesh networking between UAVs and ground nodes to provide redundant communications paths;
(b) dynamic bandwidth allocation and prioritization for safety-critical messages and anomaly evidence uploads;
(c) encrypted data transport and integrity verification; and
(d) store-and-forward behavior when communications are degraded, with later synchronization to ground systems.

Operational Methodology (example embodiments). An inspection mission may include:
(a) mission planning to define inspection zones, sensor tasking, safety constraints, and timing windows;
(b) synchronized swarm deployment and baseline data collection to establish expected conditions;
(c) adaptive inspection execution with dynamic replanning driven by environmental inputs and detected anomalies;
(d) automated report generation and distribution to authorized personnel; and
(e) post-mission data archiving and model update workflows.

Algorithm Fundamentals (example embodiments). The control and analysis stack may implement:
(a) swarm coordination methods including distributed consensus, auction-based task allocation, and formation control;
(b) path planning methods including coverage planning and obstacle avoidance (e.g., grid/graph-based planning, sampling-based planning);
(c) anomaly detection methods including computer vision models for imagery, thermal anomaly models for IR data, and statistical/ML models for time-series sensors;
(d) risk scoring and decision support to prioritize anomalies for human review; and
(e) system adaptation logic to modify mission parameters based on environmental changes, faults, or safety triggers.

Adaptability and Scalability Features (example embodiments). The system may provide:
(a) modular architecture enabling addition or removal of UAVs, sensors, and compute nodes without redesign;
(b) facility-specific configuration profiles for different launch pads, towers, and vehicle geometries;
(c) scalability across mission sizes, from single-vehicle inspections to multi-asset range inspections;
(d) technology insertion pathways for upgraded sensors, communications, and processing capabilities; and
(e) operational mode flexibility across pre-launch, launch attempt recycle, and post-launch phases.

### Implementation Examples (Non-Limiting)

The following examples are provided to illustrate concrete implementations and are not intended to limit the scope of the claims.

Example 1—Pre-Launch Zone-Based Coverage. In one implementation, a launch vehicle (310) on a pad is segmented into inspection zones (331-333) based on height and risk. A swarm of UAVs is assigned zone tasks such that at least two UAVs provide overlapping sensor coverage (340) for each zone to reduce occlusion and increase anomaly confidence. The control system assigns UAVs to zones using a task allocation process that considers battery state, sensor payload, and communications quality. UAVs cycle through inductive charging at a charging station (350) to maintain continuous coverage without halting the inspection.

Example 2—Anomaly Detection and Evidence Packaging. In one implementation, each UAV performs edge processing to compute candidate anomalies from imagery and IR data (e.g., unexpected thermal gradients, missing thermal protection, or surface damage). Candidate anomalies are assigned confidence scores and are transmitted over encrypted links (270) to a ground node. The data processing system performs multi-UAV evidence fusion (e.g., combining multiple viewing angles) and generates an automated report that includes annotated images, the estimated location on the vehicle or infrastructure, and a recommended follow-up action.

Example 3—Environmental Adaptation and Keep-Out Enforcement. In one implementation, environmental monitoring (410) provides real-time wind and lightning risk metrics. If a threshold is exceeded, the adaptive mission control system (420) issues a mission replanning command to (i) increase stand-off distances, (ii) reduce altitude, (iii) route UAVs away from hazardous regions, and/or (iv) initiate an abort and recovery sequence. The safety management system (440) enforces keep-out zones (441) and directs UAVs to an emergency landing zone (360) if required.

Example 4—Post-Launch Rapid Assessment. In one implementation, immediately after launch, a subset of UA Vs equipped with enhanced thermal protection (220) is deployed to inspect pad structures such as flame deflectors and deluge systems. IR sensing is used to identify hotspots and potential structural damage, while visual sensing is used to document debris impact regions. The system prioritizes hazard identification and generates a rapid assessment report for range safety and ground operations personnel.

Example 5—Illustrative Task Allocation Procedure. In one implementation, task allocation can be performed using an auction-based or consensus-based mechanism. The following pseudocode illustrates one non-limiting approach:

```
Inputs: Zones Z = {z1..zn}, UAVs U = {u1..um}
For each zone zi: define required sensors, coverage priority, and
time window
For each UAV uj: compute capability score c(uj, zi) based on
sensors, battery, range, comms
Repeat until all zones assigned or no feasible assignments
remain:
  Each UAV bids on the best available zone based on c(uj, zi)
  Controller selects highest bid per zone (or uses distributed
consensus to resolve conflicts)
  Assign UAVs to zones and generate coverage paths with
separation constraints
  If UAV fault or battery low: re-run allocation for affected
zones
```

The embodiments and examples described herein are illustrative. The features described in connection with particular embodiments may be combined, omitted, or modified in various ways while remaining within the scope of the appended claims.

1. A system for automated inspection of a space launch vehicle and associated launch infrastructure, the system comprising:
a plurality of unmanned aerial vehicles (UAVs), each UAV comprising a propulsion system, an onboard processor, a communication module, and a modular sensor mount configured to support a sensor suite comprising at least one of (i) a visible-light imaging sensor, (ii) an infrared sensor, and (iii) a gas detection sensor; and
a control system comprising one or more computing devices in communication with the plurality of UAVs, the control system configured to:
(i) define a set of inspection zones corresponding to portions of the space launch vehicle and/or the associated launch infrastructure;
(ii) allocate inspection tasks among the plurality of UAVs based on at least one of sensor availability, battery state, and environmental conditions;
(iii) coordinate flight paths of the plurality of UAVs to collect sensor data for the inspection zones while maintaining separation constraints and avoiding restricted areas; and
(iv) process the collected sensor data to detect anomalies and generate an inspection report.

2. The system of claim 1, wherein each UAV comprises a heat-resistant shell and thermal protection materials.

3. The system of claim 1, wherein each UAV comprises electromagnetic interference (EMI) shielding and interference-resistant electronics.

4. The system of claim 1, wherein each UAV comprises a redundant propulsion system comprising primary motors and backup motors, and wherein the control system is configured to command an automatic switchover upon detection of a propulsion fault.

5. The system of claim 1, wherein the control system is configured to implement a mesh network among the plurality of UAVs to provide redundant communication links.

6. The system of claim 1, wherein the control system is configured to enforce a keep-out zone around the space launch vehicle and/or the associated launch infrastructure, the keep-out zone dynamically updated based on real-time environmental monitoring.

7. The system of claim 1, wherein processing the collected sensor data comprises fusing sensor data captured by at least two UAVs for a same inspection zone.

8. The system of claim 1, wherein processing the collected sensor data comprises applying a machine-learning model to classify an anomaly detected in the sensor data and assign a confidence score.

9. The system of claim 1, further comprising a charging station comprising an inductive charging interface, wherein the control system is configured to schedule rotation of UAVs between inspection and charging based on battery state to maintain continuous inspection coverage.

10. The system of claim 1, wherein the control system is configured to coordinate the inspection with launch countdown procedures by receiving status data from a launch control system and adjusting at least one of inspection timing and UAV trajectories based on the status data.

11. The system of claim 1, wherein the inspection report comprises annotated imagery and geospatial references for detected anomalies.

12. The system of claim 1, wherein the control system is configured to store inspection results in a database and to perform trend analysis to support predictive maintenance.

13. A method for automated inspection of a space launch vehicle and associated launch infrastructure using a plurality of unmanned aerial vehicles (UAVs), the method comprising:
defining inspection zones corresponding to portions of the space launch vehicle and/or the associated launch infrastructure;
allocating inspection tasks among the plurality of UAVs based on at least one of sensor availability, battery state, and environmental conditions;
commanding the plurality of UAVs to execute coordinated flight paths to collect sensor data for the inspection zones while maintaining separation constraints and avoiding restricted areas; and
processing the collected sensor data to detect anomalies and generate an inspection report.

14. The method of claim 13, wherein allocating the inspection tasks accounts for at least one of wind, precipitation, and lightning risk metrics, and further comprises dynamically replanning in response to changes in the risk metrics.

15. The method of claim 13, further comprising enforcing a keep-out zone and cooperative collision avoidance among the plurality of UAVs.

16. The method of claim 13, wherein processing the collected sensor data comprises fusing sensor data from multiple UAVs to reduce occlusions and increase anomaly confidence.

17. The method of claim 13, wherein processing the collected sensor data comprises applying a machine-learning model to classify anomalies and compute confidence scores.

18. The method of claim 13, further comprising transmitting at least a portion of the sensor data over encrypted communication links and verifying data integrity.

19. The method of claim 13, further comprising rotating UAVs through an inductive charging station based on battery state to maintain continuous inspection coverage.

20. The method of claim 13, further comprising after a launch event, performing a post-launch rapid assessment using at least one UAV equipped with thermal protection and infrared sensing.
